(19) United States
(12) Patent Application Publication
(10) Pub. No.: US 2023/0050007 A1
(43) Pub. Date: Feb. 16, 2023

(54) SYSTEM SECURITY

(71) Applicant: Tegere, Inc., Gilbert, AZ (US)

(72) Inventor: Marwan HANNON, Fairfield, CA (US)

(21) Appl. No.: 17/884,064

(22) Filed: Aug. 9, 2022

Related U.S. Application Data
(60) Provisional application No. 63/231,519, filed on Aug. 10, 2021.

(51) Int. Cl. G06F 21/57; G06F 21/55

(52) U.S. Cl. CPC G06F 21/57; G06F 21/554; G06F 2221/2129; G06F 2221/2141

(57) ABSTRACT

In accordance with embodiments of this disclosure, a method of securing a processing unit according to some embodiments includes receiving a request for access from a user; detecting a device; determining whether the device is a trusted device; and providing the user access to the processing unit only if the device is a trusted device. In some embodiments, the trusted device may be a Bluetooth device.

### RELATED APPLICATIONS

This disclosure claims priority to U.S. Prov. App. 63/231,519 to Marwan Hannon, filed on Aug. 10, 2021, which is herein incorporated by reference in its entirety.

### TECHNICAL FIELD

Embodiments of the present invention are related to security for various computerized systems.

### DISCUSSION OF RELATED ART

Computer systems are ubiquitous in modern society and control many important systems. These systems can be systems dedicated to data systems, for example financial or medical systems, that process highly confidential user information. Additionally, many of these systems can control complex systems, for example utility equipment such as pipelines or electrical grids, transportation systems, autonomous vehicles or other such systems. Many of these systems are capable of sensing their environments and controlling devices that operate within that environment. For example, autonomous vehicles are being developed for a multitude of applications. Autonomous vehicles are under development and are various stages of deployment in all areas of transportation, including, but not limited to, marine shipping, aviation, trucking, passenger vehicles, rail, agricultural and industrial vehicles. A fully autonomous vehicle is capable of sensing its environment and making operational decisions to operate the vehicle without human involvement.

These systems have increasingly at risk of attack from outside bad actors. Breaches of these systems can result, and have resulted in, exposure of user confidential information (e.g., credit card information, personal information, medical information, etc.) as well as disruption of services that result from malignant access to the computer systems. Further, breaches of autonomous vehicles, whether they be passenger vehicles, constructions vehicles, agricultural implements, freight haulers (e.g., trucks or ships) or other autonomous devices can result in substantial injury and destruction of property.

Therefore, there is a need to develop security protocols to prevent malignant hacking in these computer systems.

### SUMMARY

In accordance with embodiments of this disclosure, a method of securing a processing unit according to some embodiments includes receiving a request for access from a user; detecting a device; determining whether the device is a trusted device; and providing the user access to the processing unit only if the device is a trusted device.

A method of operating a trusted device to secure a processing unit according to some embodiments includes receiving a device query from the processing unit; verifying a user; and if the user is verified, sending an ID to the processing unit.

A method of registering a device to secure a processing unit as a trusted device according to some embodiments includes receiving a request to register the device from a user; verifying the user as an administrator of the processing unit; if the user is verified as an administrator of the processing unit, detecting one or more devices; reporting the one or more devices to the user; receiving an identified device of the one or more devices from the user; and storing the identified device as the trusted device with the processing unit.

These and other embodiments are discussed below with respect to the following figures.

### BRIEF DESCRIPTION OF THE FIGURES

FIG. 1 illustrates an example computer system in a communications environment.

FIG. 2 illustrates a schematic of a computer system according to some embodiments.

FIG. 3A illustrates state function for operating a computer system according to some embodiments.

FIG. 3B further illustrates a communications and operation of a computer system according to some embodiments.

FIG. 4 illustrates an example process for compiling a list of a trusted device.

These figures are further discussed below.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description illustrates inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

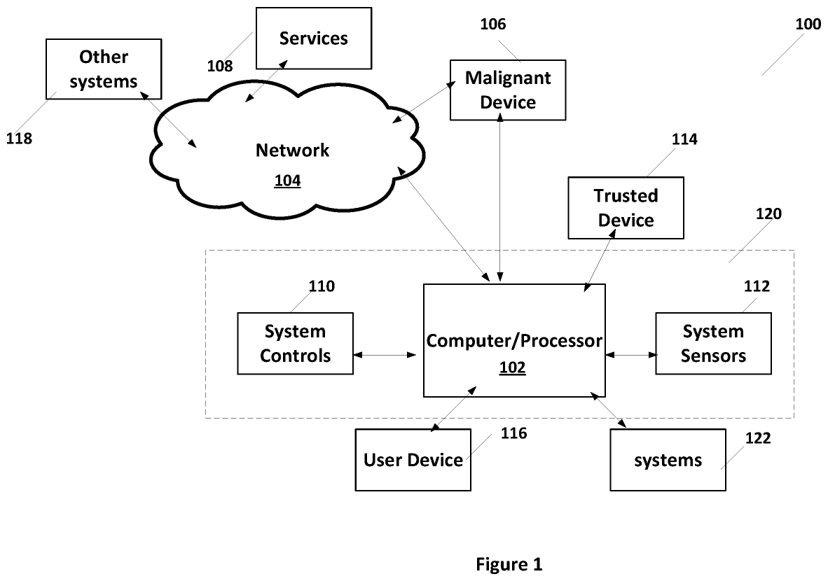

FIG. 1 illustrates aspects of the communications environment 100 of a computer or processor 102 that may be part of a system 120. System 120 can by any computer-based system, including but not limited to financial computing centers, utility control systems, transportation systems, autonomous systems (e.g., autonomous vehicles), or any other system. As is illustrated in FIG. 1, computer system 102 of system 120 can be coupled to a cloud-based network 104, through which it may access one or more services 108 or one or more other systems 118. Services 108 can be any cloud-based application, for example services for monitoring, storage, communications, or updating activities. For example, services 108 may include autonomous vehicle services that can be available if system 120 is an autonomous vehicle. Services 108 can, for example, monitor operating parameters, updates software, provide navigation and traffic control, and perform other tasks for the vehicle of system 120 on which system 102 resides. Services 108 can also be subscription services that provide services such as, for example, navigational maps and other specific data to computer system 102 of system 120.

Furthermore, computer system 102 can communicate with other systems 118 through network 104 or closely located systems 122 through wireless communications. Other systems 118 or system 122 can, for example, be traffic control systems, service information systems, other systems having computer systems such as system 102.

As is illustrated in FIG. 1, in some embodiments system 120 can include system controls 110 and system sensors 112. System controls 110 and system sensor 112 are coupled to computer system 102. System controls 110 can be, for example, remote devices that control utility devices (e.g. transformers, pipeline controls, networking switches, etc.), vehicle control systems (acceleration, steering), peripheral control systems (agricultural implements, robotic implements, etc.) or other physical devices. System sensors 112 can be various sensors that are positioned to monitor system 120 to operate system 120. For example, if system 120 is an autonomous vehicle, sensors 112 can include video imaging, laser imaging (LIDAR), radar, sonar, geographical location (GPS), detectors for road markers (active signs, traffic lights, etc.), or other sensors used by the vehicles. A ship may further include sensors for wind, water depth, radar, or other systems. System controls 110 can control vehicle heading, speed, or other vehicle controls.

Further, as is illustrated in FIG. 1, computer system 102 is also in communication with a user device 116. User device 116 can be any associated device, for example a smart phone, computer, wearable device, tablet, or other device that is capable of communicating with an end user and with computer system 102. User device 116 may, in some cases, also communicate with network 104.

However, as is further illustrated in FIG. 1, a malignant device 106 (e.g. a hacker) may also be present in the system. Hacking a computer system may well become a national pastime for hackers who will have billions of systems to hack. Embodiments of the present disclosure illustrate prevention of hacking or other unauthorized access to computer system 102. Embodiments of the present disclosure are directed to prevention of access to system 120 by malignant device 106.

In particular, in accordance with aspects of the present disclosure, computer 102 allows access to a user through user device 116 only in the presence of a trusted device 114. Trusted device 114 is a device that has been previously registered as a trusted device in computer system 102. Computer system 102 can detect the presence of trusted device 114, for example, using Bluetooth, or other wireless or wired system. Trusted device 114 may use any communications, for example wireless communications, method for communicating with computer 102. Additionally, in some aspects of the disclosure, trusted device 114 verifies the identity of the user of user device 116. Such verification can be performed biometrically (e.g., fingerprint, facial recognition, etc.), although the use of passwords may also be used. In some embodiments, user device 116 may include trusted device 114.

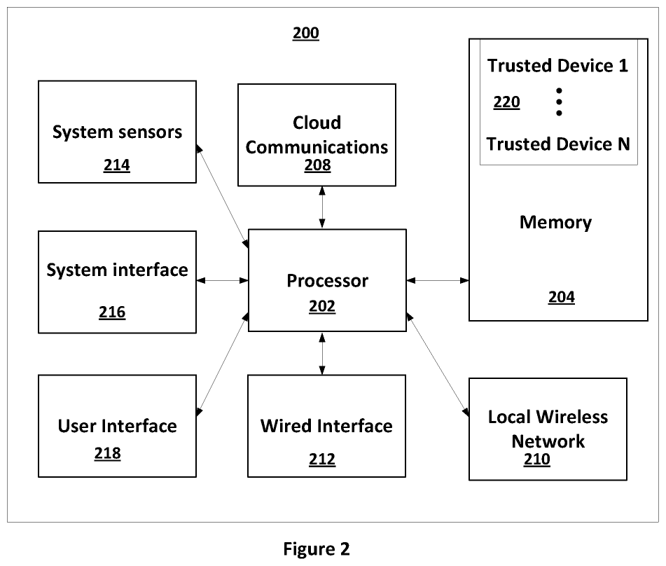

FIG. 2 illustrates an example of a processing unit 200 that further illustrates operation of computer 102. As illustrated in FIG. 2, processing unit 200 of computer 102 includes a processor 202 and memory 204. Memory 204 can include any combination of forms of data storage, including volatile and non-volatile memory, removable storage such as CDs, solid state drives, USB drives, or other types of storage. Memory 204 stores instructions and data that are used to operate computer system 102. In particular, processor 200 operates the instructions stored in memory 204, using the data stored in memory 204, to execute the methods described in further detail below.

Processor 204 can be any combination of microprocessors, microcomputers, application specific ICs (ASICs), state functions, or other devices or combinations of devices that are capable of operating as described below. Processor 204 can include numerous individual processors, which are capable of performing the functions of system 120.

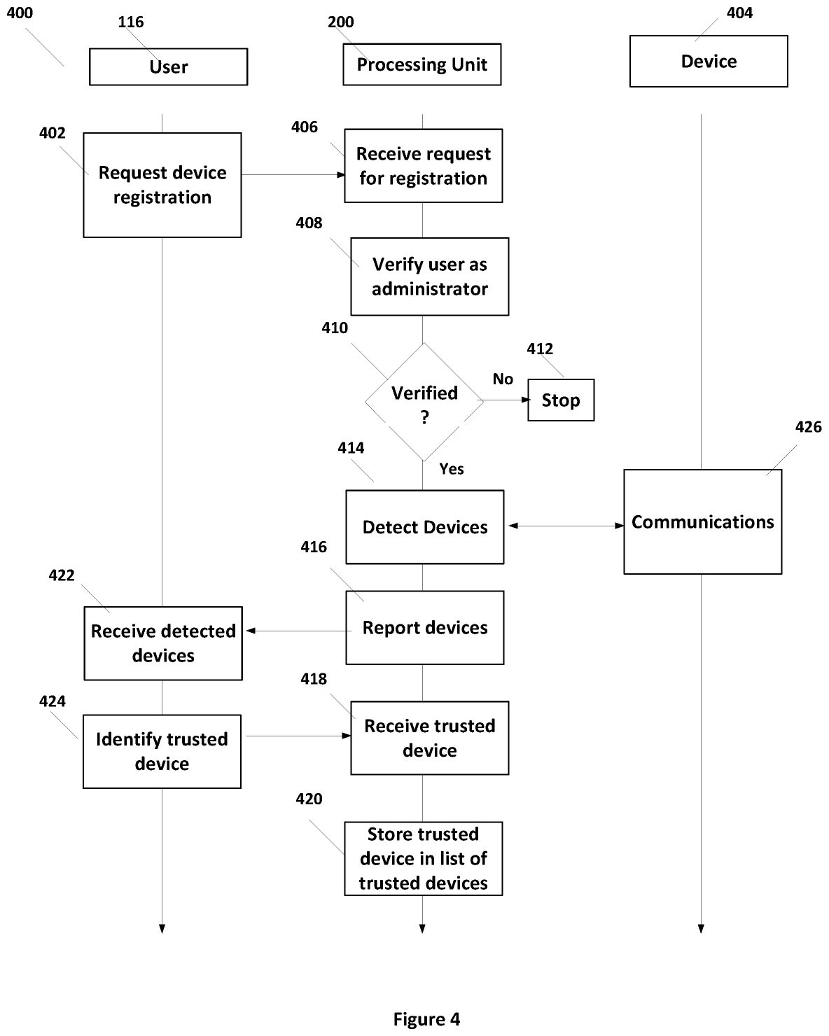

As illustrated in FIG. 2, a list 220 of trusted devices (Trusted Device 1 through N) are stored in memory 204. Each of trusted devices 1 through N are associated with at least one particular user. List 220 can be compiled, for example, as illustrated in FIG. 4 below. In order for a particular user to obtain access to computer system 102, computer system 102 must detect a device that has an identification that is listed in the trusted device list 220 in memory 204.

As is further illustrated in FIG. 2, processor 202 is coupled to various interfaces to exchange data with other devices. For example, processor 202 can be coupled to cloud communications 208 for communications with network 104 (through which services 108 operates, for example). Processor 202 is further coupled to provide a local wireless network 210, which can provide WiFi services, Bluetooth connections, or other wireless connections to local devices such as user device 116 and trusted device 114, for example. Alternatively, processor 202 may also be coupled to a wired interface 212 (e.g., ethernet, USB, or other such interface) that can be accessed by user device 116 and/or trusted device 114.

As is further illustrated, processor 202 is coupled to a system interface 216 that interfaces with components of system 120 so that processing unit 200 can control operation of the site (e.g. utility system or other system). In an autonomous vehicle, for example, system interface 216 can interface to system controls 110 that include controls for steering and acceleration, monitoring of vehicle operations, etc. In a pipeline control system, system interface 216 can communicate with system controls 110 that include valves and other such devices.

As is further illustrated, processor 202 is further coupled to a system sensors interface 214 that interfaces to system sensors 112 that includes, for example, all sensors incorporated in system 100. In an autonomous vehicle, for example, system sensors 112 can include, for example, GPS navigation, inertial sensors, radar, LIDAR, cameras, ultrasound, or other sensors that allow processing unit 200 to “see” its surroundings. In a pipeline system, for example, system sensors 112 can include, for example, flow sensors, temperature gauges, and other systems that monitor operation of the pipeline.

Processor 202 is also coupled to a user interface 218. User interface 218 can include any combination of video displays, touch screens, buttons, knobs, keyboards, audio microphones, speakers, and other devices that allows processing unit 200 to relay information (e.g., provide infotainment services, display GPS maps, provide vehicle specific messages, etc.) and receive input (e.g., vehicle parameter settings, radio stations, environmental controls, etc.) from a user of vehicle 102. User device 116 can be, for example, incorporated into user interface 218 or user device 116 may interface with computer system 102 through wireless interface 210 or wired interface 212.

In accordance with aspects of the present disclosure, memory 204 includes, along with the trusted devices list 220, instructions that interact with services 108 and user device 116 to prevent hacking as discussed further below. In particular, as discussed below when a user requests access to computer system 102 through user device 116, computer system 102 detects presence of a trusted device 114 that may have separately verified the identity of the user.

Once user device 116 is paired with processing unit 200 and services 108, user device 116 can be used access computer system 102 and direct computer system 102 to access services 108 through cloud network 104. In some aspects, trusted device 114 may be queried periodically while the user is accessing computer system 102 to verify that the user continues to be present. Any instructions sent to computer system 102 can be verified prior to those commands being executed. A hacker trying to hack into computer system 102, then, will be thwarted by the verification process that requires the presence of trusted device 114. If the computer system 102 does not detect the presence of trusted device 114 (e.g. via Bluetooth), then the computer system 102 may send all identifying info from the hackers to a central repository to build a database for law enforcement investigation. The computer system 102, or a monitoring system through network 104, can further use an AI to look for patterns to identify Hackers.

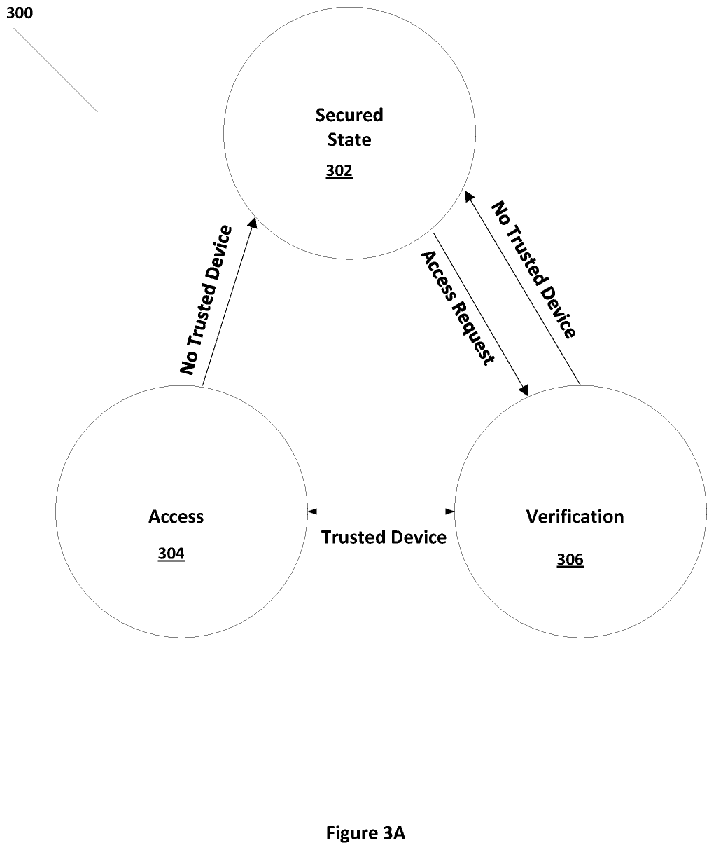

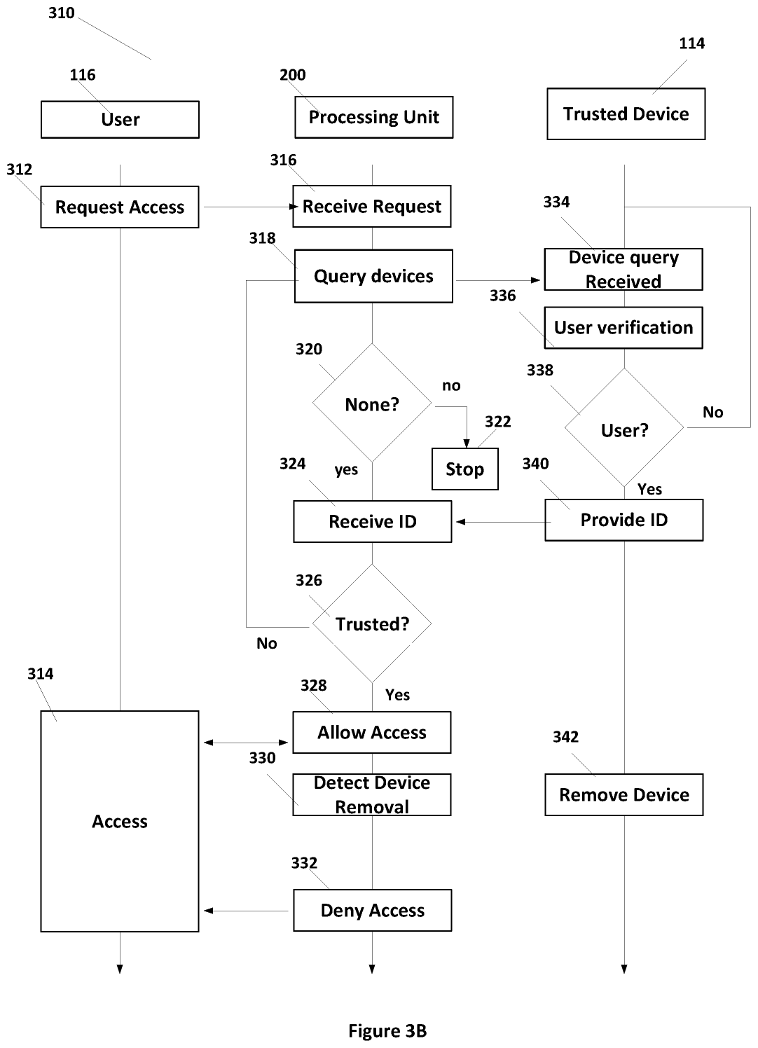

FIG. 3A illustrates a state function 300 for operation of computer system 102 that includes processor 200 as illustrated in FIG. 2. As illustrated in FIG. 3A, state function 300 includes a secured state 302, where no access to a user is provided. As illustrated, when an access request is received state function 300 transitions from secured state 302 to verification state 306. In verification state 306, computer system 102 determines whether a trusted device is present, for example by communicating with the trusted device via Bluetooth. If no trusted device is present, then state function 300 returns to secured state 302. If a trusted device is present, then verification state 306 transitions to access state 304. In access state 304, computer system 102 allows the user access to computer system 102. Access state 304 is alerted if the trusted device detected in verification state 306 is no longer present. If the trusted device is no longer present, then access state 304 transitions to secured state 302.

FIG. 3B further illustrates operation of computer system 102 as is illustrated in FIG. 3A. As is illustrated in FIG. 3B, the operations of a user through user device 116, processing unit 200 of computer system 102, and a trusted device 114 is depicted. As illustrated in FIG. 3B, user 116 requests access to computer system 102 in step 312 of user device 116. The request is received by computer system 102 in step 316. The request can come from user device 116 or from another device such as malignant device 106. In some embodiments, the user request may come from network 104. Processing unit 200 then proceeds to step 318, where nearby devices are queried to confirm their presence. In step 334 operating on a device 114, the device query is received in device 114 in step 334. In step 336, device 114 verifies the identity of the user. This verification operation can be performed with biometrics (e.g., facial recognition, fingerprint recognition, etc.) or by password access, which is input to device 114 or may be input to device 116 that is in communications with device 114. In step 338, if the user is not verified then device 114 does not respond and awaits a new device query. If the user is verified in step 338, then device 114 provides an identification, e.g. a unique Bluetooth ID, to processing unit 200. In some embodiments, the verified user can also be provided to processing unit 200.

In processing unit 200, if in response to query devices 318 there are no unqueried devices as determined in step 320, the processing unit 200 proceeds to step 322 where the access procedure is stopped. Otherwise, processing unit received the ID from device 114 in step 324 and proceeds to step 326. In step 326, processing unit 200 determines from the ID whether device 114 is listed in the trusted device list 220 and, in some cases, is associated with the particular user. In some embodiments, processing unit 200 may also verified user receiver from device 114 is associated with the ID. If not, then processing unit 200 returns to step 318 to search for another device 114. If it is on list 114, then processing unit 200 proceeds to step 328 where access is allowed. User device 116 is then provided access 314 to computer system 102. In step 330 of processing unit 200, removal of the trusted device 114 can be detected. If that removal is detected, processing unit 200 proceeds to step 332 where access is again denied to computer system 102.

FIG. 4 illustrates an example of a procedure 400 to add (register) a trusted device to trusted device list 220. As illustrated in FIG. 4, procedure 400 begins when a user requests device registration to computer system 102 through user device 116 in step 402. The request is received by processing unit 200 in step 406. In step 408, the user is verified as having administrator privileges to computer system 102. This verification may take many forms, including ones similar to process 310 illustrated in FIG. 3B using a trusted device 114 associated with the user and listing of the user in processing unit 200 as an administrator. In some embodiments, verification step 408 may include further verification or hard-wired dongle access through wired interface 212 of processing unit 200. In step 410, if the user is not verified as an administrator then procedure 400 proceeds to stop, or return to normal operations, in step 412 and access to the user is not provided. As used here, an administrator is a user that is provided a security status sufficiently high to enter trusted devices into memory 204.

In step 410, if the user is verified as an administrator then procedure 400 proceeds to step 414. In step 414, processor 200 detects available devices 404. Although a single available device 404 is illustrated in FIG. 4, there may be a number of devices 404 present. These devices 404 are not yet trusted by processing unit 200. Detecting devices 404 can be accomplished by communicating with each device 404 and receiving IDs from each of them. In step 426 of device 404, device 404 receives communications from processing unit 200 and responds with its ID. Device 404 may further provide indications whether it can verify the identity of a user (which may or may not be the administrative user). In step 416, processing unit 200 reports the identified devices 404 to step 422 in user device 116. In step 424, the administrative user selects one of the detected devices 404 to register as a trusted device. Subsequently, step 424 reports the trusted device to step 418 in processing unit 200. Finally, in step 420, device 404 is recorded as a trusted device 114 by being added to trusted device list 220. As discussed above, in some embodiments device 114 may be a Bluetooth device and the ID may be a unique Bluetooth ID.

In some embodiments, the trusted device is a Bluetooth device that is in the immediate vicinity of computer 102, which itself interacts with its surroundings. In some embodiments, computer 102 may be coupled through network 104 to other systems 118 that are situated to operate in their surroundings. Access to computer 102 as described above can provide remote access to the further connected systems. Further access to other systems 118 as described above may provide that user with access to computer system 102.

Phishing attacks are a common problem these days. Embodiments of the present disclosure can be used to prevent phishing attacks as well. Phishing attacks would be received, typically, at user device 116, and possibly at processing unit 200 as a request for action. In some embodiments, AI can be used to read the sender's email address and compare with actual emails or communications from services 108 and, if they are not the same, delete or quarantine the emails. These emails, that typically would spoof communications from services 108, can be stored and analyzed as well.

Embodiments of the invention described herein are not intended to be limiting of the invention. One skilled in the art will recognize that numerous variations and modifications within the scope of the present invention are possible. Consequently, the present invention is set forth in the following claims.

What is claimed is:

1. A method of securing a processing unit, comprising:
receiving a request for access from a user;
detecting a device;
determining whether the device is a trusted device; and
providing the user access to the processing unit only if the device is a trusted device.

2. The method of claim 1, wherein the trusted device is associated with the user and providing access includes verifying that the user is the one associated with the trusted device.

3. The method of claim 1, wherein the device is a Bluetooth device.

4. The method of claim 1, wherein the device is coupled to the processing unit by direct connection.

5. The method of claim 1, further including removing the device and denying access to the user in the absence of the device.

6. The method of claim 1, wherein detecting a device includes
querying devices; and
receiving IDs from devices to determine a trusted device.

7. The method of claim 1, wherein determining whether the device is a trusted device by determining that a unique ID provided by the device is included in a recorded list of trusted devices.

8. A method of operating a trusted device to secure a processing unit, comprising:
receiving a device query from the processing unit;
verifying a user; and
if the user is verified, sending an ID to the processing unit.

9. The method of claim 8, wherein verifying the user includes biometric authentication of the user.

10. The method of claim 8, wherein the trusted device is a Bluetooth device.

11. The method of claim 8, wherein the trusted device is directly connected to the processing unit.

12. A method of registering a device to secure a processing unit as a trusted device, comprising:
receiving a request to register the device from a user;
verifying the user as an administrator of the processing unit;
if the user is verified as an administrator of the processing unit,
detecting one or more devices;
reporting the one or more devices to the user;
receiving an identified device of the one or more devices from the user; and
storing the identified device as the trusted device with the processing unit.

13. The method of claim 12, wherein verifying the user as an administrator includes
detecting a trusted device associated with the user;
if the trusted device is detected, determining that the user is an administrator.

14. The method of claim 12, wherein the processing unit is included in a system.

15. The method of claim 14, wherein the system is an autonomous vehicle.

16. The method of claim 14, wherein the system is a utility.
